(19) United States
(12) Patent Application Publication
(10) Pub. No.: US 2026/0104770 A1
(43) Pub. Date: Apr. 16, 2026

(54) TOUCH MODULE, DISPLAY DEVICE INCLUDING THE SAME, AND ELECTRONIC DEVICE INCLUDING THE SAME

(71) Applicant: SAMSUNG DISPLAY CO., LTD., YONGIN-SI (KR)

(72) Inventors: JUNGHA SON, Yongin-si (KR); JUNGHAK KIM, Yongin-si (KR); YUN A MA, Yongin-si (KR); SANGWOOK YOO, Yongin-si (KR); JEONGHEON LEE, Yongin-si (KR)

(21) Appl. No.: 19/221,823

(22) Filed: May 29, 2025

(30) Foreign Application Priority Data
Oct. 16, 2024 (KR) 10-2024-0141524

(51) Int. Cl. G06F 3/041; G06F 3/044

(52) U.S. Cl. CPC G06F 3/04164; G06F 3/04166; G06F 3/0446

(57) ABSTRACT

A touch module includes a touch panel including touch electrodes, and a touch panel driver configured to provide a touch driving signal to the touch panel and detect a touch of an object based on a touch sensing signal received from the touch panel in response to the touch driving signal. The touch panel is a self-dot type, and the touch panel driver includes touch drivers, and each of the touch drivers is configured to provide a touch driving signal having a different frequency to the touch panel.

### CROSS-REFERENCE TO RELATED APPLICATION(S)

This U.S. patent application claims priority under 35 USC § 119 to Korean Patent Application No. 10-2024-0141524 filed on Oct. 16, 2024 in the Korean Intellectual Property Office (KIPO), the disclosure of which is incorporated by reference in its entirety herein.

### 1. Technical Field

Embodiments of the present inventive concept are directed to a touch module, a display device including the same, and an electronic device including the same. More particularly, the embodiments are directed to a touch module, a display device including the same, and an electronic device including the same for reducing Electromagnetic interference (EMI).

### 2. Discussion of Related Art

A touch module is a device to detect user input actions or events. The touch module may include a touch panel and a touch panel driver for driving the touch panel. The touch panel may be mounted on a surface of a display panel or integrated within the display panel.

When the touch panel is touched by a conductive object, such as a user's body or a stylus pen, it may generate an electrical signal. The touch panel driver may detect the presence a location of the touch based on the electrical signal.

Driving the touch panel driver may generate electromagnetic interference (EMI), which is an unintended noise that can adversely affect the operation of electronic devices. As the size of the touch panel increases, the amount of EMI also tends to increase. Moreover, enhancing touch performance often requires applying higher voltages to the touch panel, which further amplifies EMI.

### SUMMARY

Embodiments of the present inventive concept provide a touch module configured to reduce EMI while maintaining high touch performance, even in large-sized touch panels, a display device including the touch panel and an electronic device including the display device.

In an embodiment of a touch module according to the present inventive concept, the touch module includes a touch panel including touch electrodes, and a touch panel driver configured to provide a touch driving signal to the touch panel and detect a touch of an object based on a touch sensing signal received from the touch panel in response to the touch driving signal. The touch panel is a self-dot type, and the touch panel driver includes touch drivers, and each of the touch drivers is configured to provide a touch driving signal having a different frequency to the touch panel.

In an embodiment, as a number of the different frequency increases, an Electromagnetic interference (EMI) may decrease.

In an embodiment, the touch electrodes included in the touch panel of the self-dot type may form touch capacitors with the object, and the touch panel driver may be configured to detect the touch of the object based on a capacitance change of each of the touch capacitors.

In an embodiment, the touch electrodes included in the touch panel of the self-dot type may be arranged along a row and a column.

In an embodiment, the touch panel may further include touch lines connected to the touch electrodes and multiplexers connected to the touch lines, and each of the touch drivers may be configured to provide the touch driving signal to each of the multiplexers.

In an embodiment, touch driving signals applied to the touch electrodes arranged adjacently along the row may have a different timing.

In an embodiment, when the touch drivers include a first touch driver configured to output a first touch driving signal having a first frequency and a second touch driver configured to output a second touch driving signal having a second frequency, the touch panel may include a first touch area and a second touch area arranged adjacently along a row, and the first touch driving signal may be applied to the touch electrodes included in the first touch area, and the second touch driving signal may be applied to the touch electrodes included in the second touch area.

In an embodiment, the first frequency and the second frequency may be different from each other.

In an embodiment, the first frequency and the second frequency may be selected such that a least common multiple of a reciprocal of the first frequency and a reciprocal of the second frequency is greater than a predetermined threshold.

In an embodiment, as the least common multiple of the first frequency and the second frequency increase, an EMI may be decrease.

In an embodiment, when the first touch driver is configured to output the first touch driving signal having the first frequency and a third touch driving signal having a third frequency and the second touch driver is configured to output the second touch driving signal having the second frequency and a fourth touch driving signal having a fourth frequency, the touch panel may further include a third touch area and a fourth touch area arranged adjacently along the row, the third touch area may be arranged adjacently to the first touch area along a column, the fourth touch area may be arranged adjacently to the second touch area along the column, the third touch driving signal may be applied to the touch electrodes included in the third touch area, and the fourth touch driving signal may be applied to touch electrodes included in the fourth touch area.

In an embodiment, the first frequency, the second frequency, the third frequency, and the fourth frequency may be different from each other.

In an embodiment of a display device according to the present inventive concept, the display device includes a display module including a display panel, and a display panel driver configured to drive the display panel, and a touch module including a touch panel, and a touch panel driver configured to drive the touch panel. The touch panel includes touch electrodes. The touch panel driver is configured to provide a touch driving signal to the touch panel and detect a touch of an object based on a touch sensing signal received in response to the touch driving signal. The touch panel is a self-dot type. The touch panel driver includes touch drivers, and each of the touch drivers is configured to provide a touch driving signal having a different frequency to the touch panel.

In an embodiment, as a number of the different frequency increases, an EMI may decrease.

In an embodiment, the touch electrodes included in the touch panel of the self-dot type may form touch capacitors with the object, and the touch panel driver may be configured to detect the touch of the object based on a capacitance change of each of the touch capacitors.

In an embodiment, the touch electrodes included in the touch panel of the self-dot type may be arranged along a row and a column.

In an embodiment, the touch panel may further include touch lines connected to the touch electrodes and multiplexers connected to the touch lines, and each of the touch drivers may be configured to provide the touch driving signal to each of the multiplexers.

In an embodiment, touch driving signals applied to the touch electrodes arranged adjacently along the row may have a different timing.

In an embodiment, when the touch drivers include a first touch driver configured to output a first touch driving signal having a first frequency and a second touch driver configured to output a second touch driving signal having a second frequency, the touch panel may include a first touch area and a second touch area arranged adjacently along a row, and the first touch driving signal may be applied to the touch electrodes included in the first touch area, and the second touch driving signal may be applied to the touch electrodes included in the second touch area.

In an embodiment of an electronic device according to the present inventive concept, the electronic device includes a processor configured to output input image data and an input control signal, a display module including a display panel, and a display panel driver configured to drive the display panel based on the input image data and an the input control signal, and a touch module including a touch panel, and a touch panel driver configured to drive the touch panel. The touch panel includes touch electrodes. The touch panel driver is configured to provide a touch driving signal to the touch panel and detect a touch of an object based on a touch sensing signal received from the touch panel in response to the touch driving signal. The touch panel is a self-dot type. The touch panel driver includes touch drivers, and each of the touch drivers is configured to provide a touch driving signal having a different frequency to the touch panel.

According to the touch module, the display device, and the electronic device, each of the touch drivers of the touch panel driver of the touch module may provide the touch driving signal having the different frequency to the touch panel 400. In addition, the touch panel may be the touch panel of the self-dot type. Therefore, the number of different frequencies may increase. Accordingly, the EMI may be reduced even when the size of the touch panel is large while maintaining high touch performance.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to an embodiment of the present inventive concept;

FIG. 2 is a conceptual diagram explaining a touch panel of a mutual type and a touch panel of a self-dot type;

FIG. 3 is a diagram showing a touch module according to an embodiment of the present inventive concept;

FIG. 4 and FIG. 5 are diagrams explaining an operation of a touch module of FIG. 3;

FIG. 6 is a diagram showing an example of an operation of a touch module of FIG. 3;

FIG. 7 is a diagram showing a touch panel of FIG. 6 divided into a first touch area and a second touch area;

FIG. 8 is a timing diagram showing a comparative example of a first touch driving signal and a second touch driving signal provided to a first touch area and a second touch area of FIG. 7;

FIG. 9 and FIG. 10 are timing diagrams showing an example of a first touch driving signal and a second touch driving signal provided to a first touch area and a second touch area of FIG. 7;

FIG. 11 is a diagram showing an example of an operation of a touch module of FIG. 3;

FIG. 12 is a diagram showing a touch panel of FIG. 11 divided into first to fourth touch areas;

FIG. 13 is a diagram showing an example of an operation of a touch module of FIG. 3;

FIG. 14 is a diagram showing a touch panel of FIG. 11 divided into first to fourth touch areas;

FIG. 15 is a diagram showing an example of an operation of a touch module of FIG. 3;

FIG. 16 is a diagram showing a touch panel of FIG. 15 divided into first to eighth touch areas;

FIG. 17 is a graph showing a change in an EMI according to a frequency of a touch driving signal;

FIG. 18 is a block diagram showing an electronic device;

FIG. 19 is a diagram showing an embodiment in which an electronic device of FIG. 18 is implemented as a car window; and

FIG. 20 is a block diagram showing the electronic device according to an example embodiment.

### DETAILED DESCRIPTION

At least one embodiment of the invention is directed to a touch module including a touch panel (e.g., a self-dot type) and a touch panel driver. The touch panel includes touch electrodes, and the touch panel driver includes multiple touch drivers, each configured to output a touch driving signal with a different frequency. These frequency-differentiated signals are applied to the touch panel to detect a touch of an object based on received touch sensing signals. By using different frequencies (e.g., across adjacent regions), the system may reduce electromagnetic interference (EMI) while still supporting high-performance touch detection on large touch panels.

Hereinafter, the present inventive concept will be described in more detail with reference to the accompanying drawings.

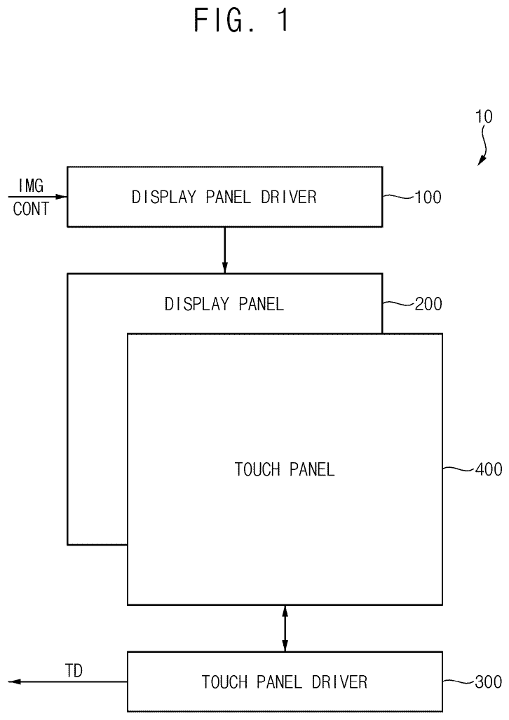

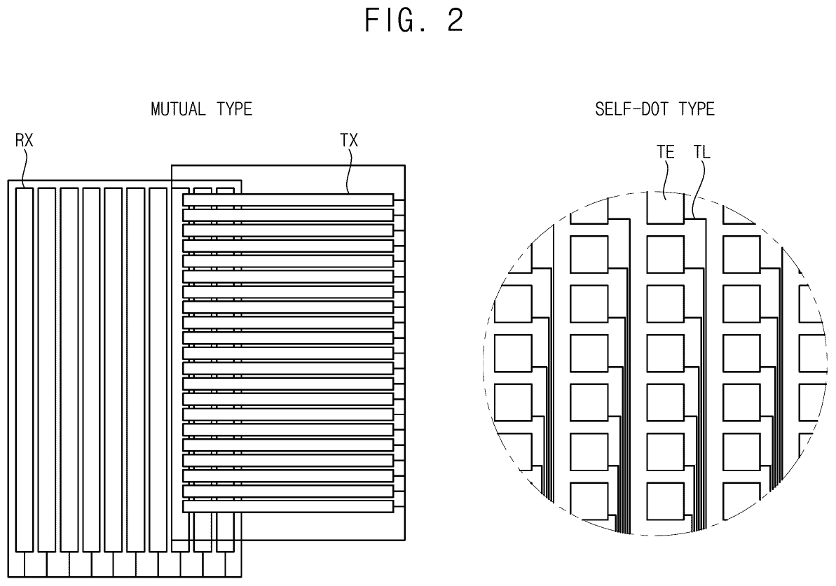

FIG. 1 is a block diagram showing a display device 10 according to an embodiment of the present inventive concept. FIG. 2 is a conceptual diagram explaining a touch panel of a mutual type and a touch panel of a self-dot type. A touch panel of a self-dot type is a type of capacitive touch panel in which each individual touch electrode independently acts as both the transmitting and receiving node, rather than having separate transmitting and receiving electrodes arranged in intersecting rows and columns (as in a mutual type).

Referring to FIG. 1, a display device 10 may include a display module configured to display an image and a touch module configured to recognize or detect user input actions or user events. The display module may include a display panel driver 100 (e.g., a first driver circuit) and a display panel 200, and the touch module may include a touch driver 300 (e.g., a second driver circuit) and a touch panel 400.

The display panel driver 100 may drive the display panel 200 to display the image. The display panel driver 100 may receive input image data IMG and an input control signal CONT from an external processor (not shown). For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The display panel driver 100 may generate a display panel driving signal based on the input image data IMG and the input control signal CONT to provide the display panel driving signal to the display panel 200. In an embodiment, the display panel driving signal may include a gate signal and a data signal, and the display panel driver 100 may include a gate driver providing the gate signal to the display panel 200, a data driver providing the data signal to the display panel 200, and a driving controller controlling the gate driver and the data driver, but is not limited thereto.

The display panel 200 may display the image based on the gate signal and the data signal.

The touch driver 300 may drive the touch panel 400 to detect a touch of an object. The touch driver 300 may generate a touch driving signal to provide the touch driving signal to the touch panel 400, and may receive a touch sensing signal from the touch panel 400. The touch driver 300 may detect the touch of the object based on the touch sensing signal (e.g., based on the touch sensing signal received in response to the touch driving signal). The touch driver 300 may generate touch data TD representing the detected touch, and may provide the touch data TD to the display panel driver 100 or an external processor.

Referring to FIG. 2, the touch panel 400 may be a touch panel of a capacitance type which detects a capacitance change (i.e., a voltage change) due to the touch of the object. The touch panel of the capacitance type may include a touch panel of a mutual type and a touch panel of a self-dot type.

The touch panel of the mutual type may include transmitting touch electrode lines TX and receiving touch electrode lines RX. For example, the transmitting touch electrode lines TX may extend along a row, and the receiving touch electrode lines RX may extend along a column. Each of the transmitting touch electrode lines TX may form touch capacitors with each of the receiving touch electrode lines RX. Each of the transmitting touch electrode lines TX may transmit the touch driving signal along the row. Therefore, touch capacitors formed between the transmitting touch electrode line TX and the receiving touch electrode lines RX along the row may receive the same touch driving signal. Each of the receiving touch electrode lines RX may transmit the capacitance change (i.e., the voltage change) due to the touch of the object as the touch sensing signal.

The touch panel of the self-dot type may include touch electrodes TE and touch lines TL connected to the touch electrodes TE. For example, the touch electrodes TE may be arranged along the row and the column, and the touch lines TL may extend along the column. The touch electrodes TE may form touch capacitors with the object. For example, each touch electrode TE may form a capacitive coupling (i.e., a touch capacitor) with an external object upon proximity or contact. Each of the touch lines TL may transmit the touch driving signal along the column. Each of the touch lines TL may transmit the capacitance change (i.e., the voltage change) due to the touch of the object as the touch sensing signal along the column.

In the present embodiment, the touch panel 400 may be the touch panel of the self-dot type.

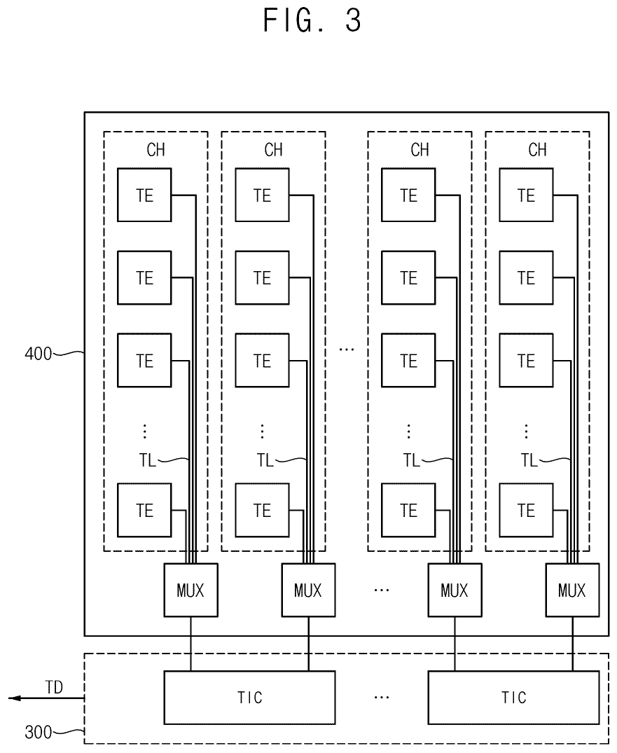

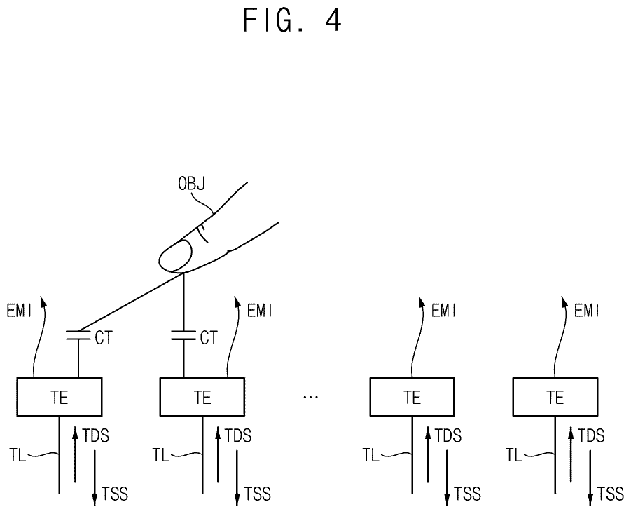

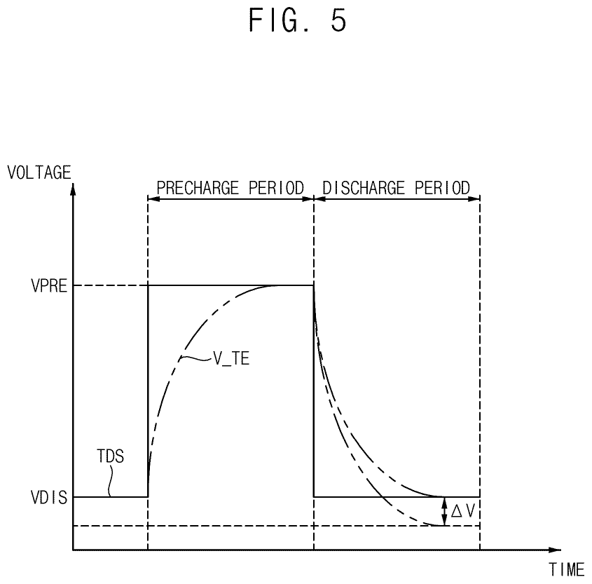

FIG. 3 is a diagram showing a touch module according to an embodiment of the present inventive concept. FIG. 4 and FIG. 5 are diagrams explaining an operation of the touch module of FIG. 3 according to an embodiment.

Referring to FIG. 3 to FIG. 5, the touch module may include the touch panel driver 300 and the touch panel 400.

The touch panel driver 300 may include touch drivers TIC. Each of the touch drivers TIC may be configured as a touch IC. In general, as the size of the touch panel 400 increases, the number of touch drivers TIC may also increase. In the present embodiment, the number of the touch drivers TIC may be at least 2 or more. In an embodiment, each of the touch drivers TIC provides a touch driving signal TDS having a different frequency to the touch panel 400 but is not limited thereto. For example, at least two of the touch drivers TIC that are adjacent one another may provide touch driving signals TDS that are different from one another.

As described above, the touch panel 400 may be the touch panel of the self-dot type. The touch panel 400 of the self-dot type may include the touch electrodes TE and the touch lines TL connected to the touch electrodes TE. For example, the touch electrodes TE may be arranged along the row and the column, and the touch lines TL may extend along the column. For example, the touch electrodes TE may be arranged in a grid pattern along rows and columns, with the touch lines TL extending along the columns. For example, the touch electrodes TE arranged along the column may form a channel CH.

The touch panel 400 may further include multiplexers MUX connected to the touch lines TL. Each of the multiplexers MUX may selectively provide the touch driving signal TDS provided from each of the touch drivers TIC to each of the touch lines TL, and each of the touch lines TL may transmit the touch driving signal TDS to each of the touch electrodes TE. For example, each multiplexer MUX may selectively route a touch driving signal TDS, received from a corresponding touch driver TIC, to one of the touch lines TL, and each touch line TL may transmit the touch driving signal TDS to its associated touch electrode TE.

The touch electrodes TE may form touch capacitors CT with the object OBJ. For example, the touch driving signal TDS may be a square wave. The touch driving signal TDS which is the square wave may swing between a precharge voltage VPRE and a discharge voltage VDIS. Specifically, the touch driving signal TDS may have the precharge voltage VPRE in a precharge period, and may have the discharge voltage VDIS in a discharge period. Accordingly, a voltage V_TE of the touch electrode TE of the touch capacitor CT may be precharged with the precharge voltage VPRE in the precharge period, and may be discharged to the discharge voltage VDIS in the discharge period.

When the touch panel 400 is touched by the object OBJ, the voltage V_TE of the touch electrode TE of the touch capacitor CT may have a voltage change ΔV. Each of the touch lines TL may transmit the voltage change ΔV as the touch sensing signal TSS to the touch drivers TIC through the multiplexers MUX. Specifically, voltages V_TE of touch electrodes TE of capacitors CT adjacent to a location of the touch may have the voltage changes ΔV. The voltage changes ΔV may vary depending on the distance between the touch location each capacitor CT. The location of the touch electrode TE exhibiting the largest voltage change ΔV may be identified as the touch location.

As the number of the touch electrodes TE increases (i.e., as the size of the touch panel 400 becomes larger), and as a difference between the precharge voltage VPRE and the discharge voltage VDIS increases, the touch function may be enhanced, but EMI may also increase.

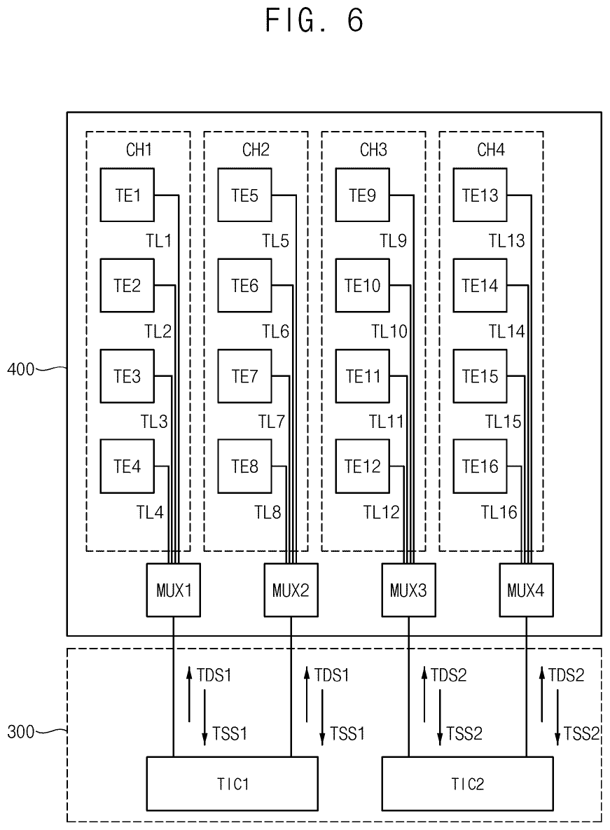

To reduce EMI while maintaining high touch performance on a large touch panel 400, the touch panel driver 300 of the touch panel 400 may include multiple touch drivers TIC, each configured to provide a touch driving signal TDS. At least two of the touch driving signals TDS may have different frequencies. In addition, the touch panel 400 may be the touch panel of the self-dot type. A specific example will be described from FIG. 6.

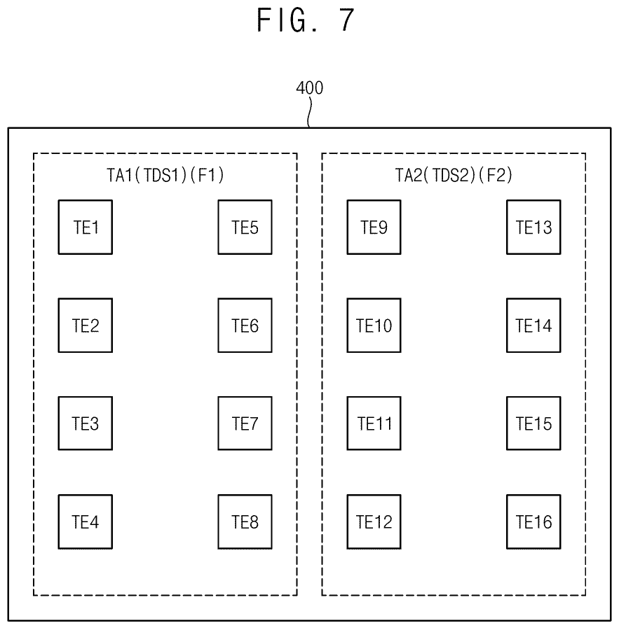

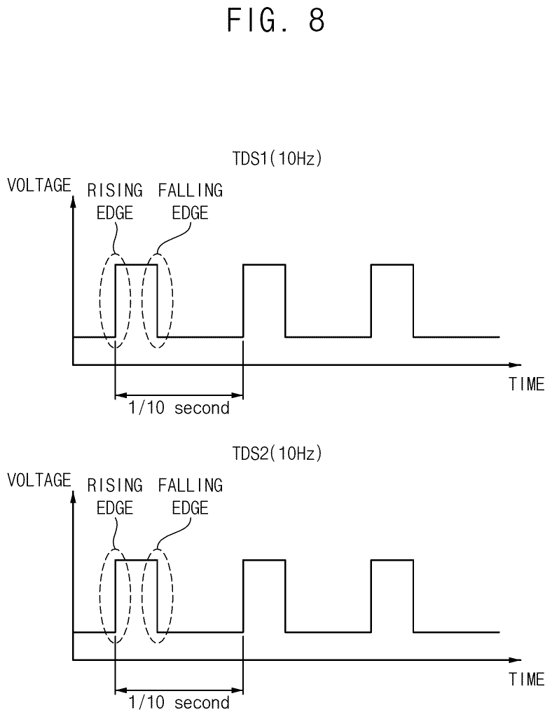

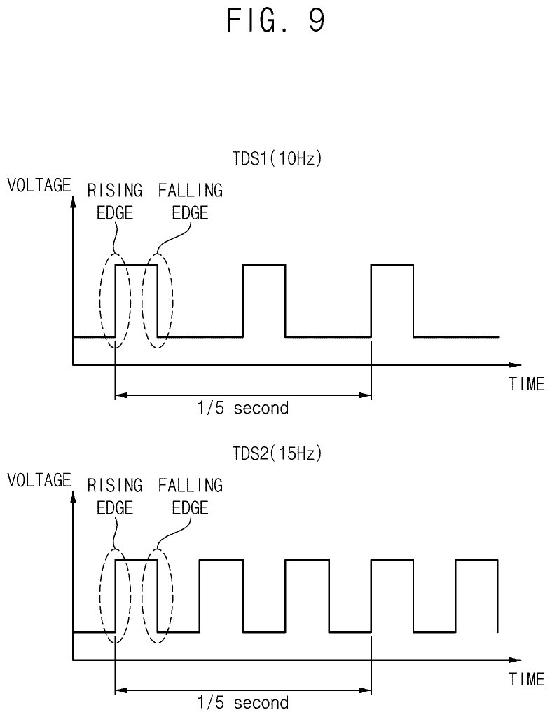

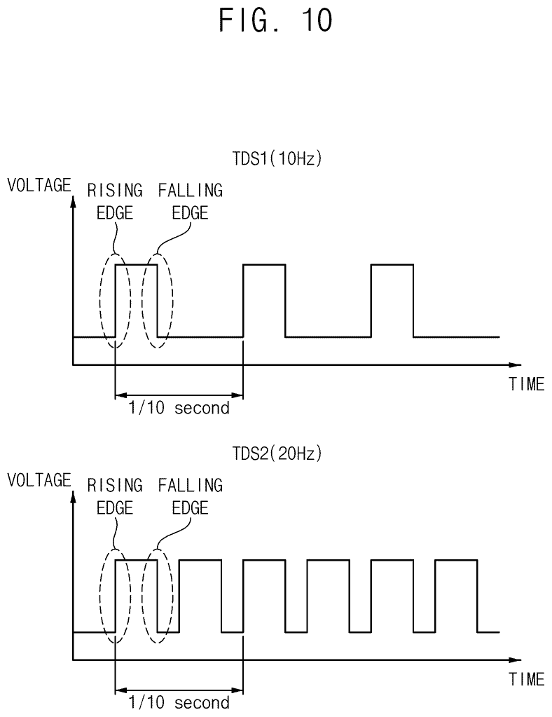

FIG. 6 is a diagram showing an example of an operation of the touch module of FIG. 3. FIG. 7 is a diagram showing a touch panel 400 of FIG. 6 divided into a first touch area TA1 and a second touch area TA2. FIG. 8 is a timing diagram showing a comparative example of a first touch driving signal TD1 and a second touch driving signal TD2 provided to the first touch area TA1 and the second touch area TA2 of FIG. 7. FIG. 9 and FIG. 10 are timing diagrams showing an example of a first touch driving signal TD1 and a second touch driving signal TD2 provided to a first touch area TA1 and a second touch area TA2 of FIG. 7.

Referring to FIGS. 6 and 7, the touch module may include the touch panel driver 300 and the touch panel 400.

The touch panel driver 300 may include the touch drivers TIC. For example, the touch drivers TIC may include a first touch driver TIC1 and a second touch driver TIC2. The first touch driver TIC1 may provide a first touch driving signal TDS1 having a first frequency F1 to the touch panel 400. The second touch driver TIC2 may provide a second touch driving signal TDS2 having a second frequency F2 to the touch panel 400. In an embodiment, the first frequency F1 is different from the second frequency F2.

The touch panel 400 may be the touch panel of the self-dot type. The touch panel 400 of the self-dot type may include the touch electrodes TE, the touch lines TL connected to the touch electrodes TE, and the multiplexers MUX connected to the touch lines TL. For example, the touch electrodes TE may include first to sixteenth touch electrodes TE1 to TE16. For example, the touch lines TL may include first to sixteenth touch lines TL1 to TL16. For example, the multiplexers MUX may include first to fourth multiplexers MUX1 to MUX4. However, the present inventive concept is not limited to the number of the touch drivers TIC (e.g., 2), the number of the touch electrodes TE (e.g., 16), the number of the touch lines TL (e.g., 16), and the number of the multiplexers MUX (e.g., 4) shown in FIG. 6.

The first to fourth touch electrodes TE1 to TE4 may form a first channel CH1 and may be connected to the first to fourth touch lines TL1 to TL4, and the first to fourth touch lines TL1 to TL4 may be connected to the first multiplexer MUX1. The first touch driving signal TDS1 having the first frequency F1 may be provided from the first multiplexer MUX1.

The fifth to eighth touch electrodes TE5 to TE8 may form a second channel CH2 and may be connected to the fifth to eighth touch lines TL5 to TL8, and the fifth to eighth touch lines TL5 to TL8 may be connected to the second multiplexer MUX2. The first touch driving signal TDS1 having the first frequency F1 may be provided to the second multiplexer MUX2.

The ninth to twelfth touch electrodes TE9 to TE12 may form a third channel CH3 and may be connected to the ninth to twelfth touch lines TL9 to TL12, and the ninth to twelfth touch lines TL9 to TL12 may be connected to the third multiplexer MUX3. The second touch driving signal TDS2 having the second frequency F2 may be provided to the third multiplexer MUX3.

The thirteenth to sixteenth touch electrodes TE13 to TE16 may form a fourth channel CH4 and may be connected to the thirteenth to sixteenth touch lines TL13 to TL16, and the thirteenth to sixteenth touch lines TL13 to TL6 may be connected to the fourth multiplexer MUX4. The second touch driving signal TDS2 having the second frequency F2 may be provided to the fourth multiplexer MUX4.

Each of the multiplexers MUX may selectively provide the touch driving signal TDS provided from each of the touch drivers TIC to each of the touch lines TL, and each of the touch lines TL may transmit the touch driving signal TDS to each of the touch electrodes TE. For example, each multiplexer MUX may selectively provide a touch driving signal TDS, received from one of the touch drivers TIC, to a corresponding touch line TL and each touch line TL may then transmit the touch driving signal TDS to its associated touch electrode TE.

For example, the first multiplexer MUX1 may provide the first touch driving signal TDS1 to the first touch electrode TE1 through the first touch line TL1, or provide the first touch driving signal TDS1 to the second touch electrode TE2 through the second touch line TL2, or provide the first touch driving signal TDS1 to the third touch electrode TE3 through the third touch line TL3, or provide the first touch driving signal TDS1 to the fourth touch electrode TE4 through the fourth touch line TL4.

For example, the second multiplexer MUX2 may provide the first touch driving signal TDS1 to the fifth touch electrode TE5 through the fifth touch line TL5, or provide the first touch driving signal TDS1 to the sixth touch electrode TE6 through the sixth touch line TL6, or provide the first touch driving signal TDS1 to the seventh touch electrode TE7 through the seventh touch line TL7, or provide the first touch driving signal TDS1 to the eighth touch electrode TE8 through the eighth touch line TL8.

For example, the third multiplexer MUX3 may provide the second touch driving signal TDS2 to the ninth touch electrode TE9 through the ninth touch line TL9, or provide the second touch driving signal TDS2 to the tenth touch electrode TE10 through the tenth touch line TL10, or provide the second touch driving signal TDS2 to the eleventh touch electrode TE11 through the eleventh touch line TL11, or provide the second touch driving signal TDS2 to the twelfth touch electrode TE12 through the twelfth touch line TL12.

For example, the fourth multiplexer MUX4 may provide the second touch driving signal TDS2 to the thirteenth touch electrode TE13 through the thirteenth touch line TL13, or provide the second touch driving signal TDS2 to the fourteenth touch electrode TE14 through the fourteenth touch line TL14, or provide the second touch driving signal TDS2 to the fifteenth touch electrode TE15 through the fifteenth touch line TL15, or provide the second touch driving signal TDS2 to the sixteenth touch electrode TE16 through the sixteenth touch line TL16.

The touch panel 400 may be divided into a first touch area TA1 to which the first touch driving signal TDS1 is provided and a second touch area TA2 to which the second touch driving signal TDS2 is provided. The first touch area TA1 and the second touch area TA2 may be arranged adjacently along the row. For example, the first touch area TA1 and the second touch area TA2 may be positioned adjacent to each other along a row direction. For example, the first touch area TA1 may include the first to eighth touch electrodes TE1 to TE8, and the second touch area TA2 may include the ninth to sixteenth touch electrodes TE9 to TE16.

Referring to FIG. 8, according to a comparative example, the first frequency F1 of the first touch driving signal TDS1 is equal to the second frequency F2 of the second touch driving signal TDS2. For example, the first frequency F1 may be 10 Hz, and the second frequency F2 may be 10 Hz. For example, a period of these signals having 10 Hz frequency may be 1/10 second.

For example, a timing of a rising edge of the first touch driving signal TDS1 may be equal to a timing of a rising edge of the second touch driving signal TDS2. For example, a timing of a falling edge of the first touch driving signal TDS1 may be equal to a timing of a falling edge of the second touch driving signal TDS2. When the timing of the rising edge of the first touch driving signal TDS1 is equal to the timing of the rising edge of the second touch driving signal TDS2 or when the timing of the falling edge of the first touch driving signal TDS1 is equal to the timing of the falling edge of the second touch driving signal TDS2, EMI may increase. When the first frequency F1 of the first touch driving signal TDS1 and the second frequency F2 of the second touch driving signal TDS2 has the same frequency of 10 Hz, the EMI may increase every 1/10 second.

Referring to FIG. 9, according to the present embodiment, the first frequency F1 of the first touch driving signal TDS1 is different from the second frequency F2 of the second touch driving signal TDS2. For example, the first frequency F1 may be 10 Hz, and the second frequency F2 may be 15 Hz. A period of a signal having a 10 Hz frequency may be 1/10 second, and a period of a signal having a 15 Hz frequency may be 1/15 second.

For example, a timing of a rising edge of the first touch driving signal TDS1 may be equal to a timing of a rising edge of the second touch driving signal TDS2. When the timing of the rising edge of the first touch driving signal TDS1 is equal to the timing of the rising edge of the second touch driving signal TDS2, EMI may increase. When the first frequency F1 of the first touch driving signal TDS1 is 10 Hz and the second frequency F2 of the second touch driving signal TDS2 is 15 Hz, the EMI may increase every ⅕ second.

Through this, it may be seen that when the first frequency F1 of the first touch driving signal TDS1 is equal to the second frequency F2 of the second touch driving signal TDS2, the EMI is relatively large, and when the first frequency F1 of the first touch driving signal TDS1 is different from the second frequency F2 of the second touch driving signal TDS2, the EMI is relatively small.

Referring to FIG. 10, the first frequency F1 of the first touch driving signal TDS1 is different from the second frequency F2 of the second touch driving signal TDS2. For example, the first frequency F1 may be 10 Hz, and the second frequency F2 may be 20 Hz. A period of a signal having a 10 Hz frequency may be 1/10 second, and a period of a signal having a 20 Hz frequency may be 1/20 second.

For example, a timing of a rising edge of the first touch driving signal TDS1 may be equal to a timing of a rising edge of the second touch driving signal TDS2. When the timing of the rising edge of the first touch driving signal TDS1 is equal to the timing of the rising edge of the second touch driving signal TDS2, EMI may increase. When the first frequency F1 of the first touch driving signal TDS1 is 10 Hz and the second frequency F2 of the second touch driving signal TDS2 is 20 Hz, the EMI may increase every 1/10 second.

Through this, it may be seen that, even if the first frequency F1 of the first touch driving signal TDS1 is different from the second frequency F2 of the second touch driving signal TDS2, the EMI may be relatively small if the least common multiple of the reciprocals of the first frequency F1 and the second frequency F2 is large. This is because the reciprocal of the first frequency F1 represents the period of the first touch driving signal TDS1, and the reciprocal of the second frequency F2 represents the period of the second touch driving signal TDS2. When the least common multiple of these periods is large, the interval at which the rising edges of the first touch driving signal TDS1 and the second touch driving signal TDS2 align becomes longer, thereby reducing the likelihood of simultaneous switching and lowering EMI. Therefore, the first frequency F1 and the second frequency F2 may be selected such that the least common multiple of the reciprocal of the first frequency F1 and the reciprocal of the second frequency F2 is large. For example, the first frequency F1 and the second frequency F2 may be selected such that a least common multiple of a reciprocal of the first frequency F1 and a reciprocal of the second frequency F2 is greater than a predetermined threshold.

As such, each of the touch drivers TIC of the touch panel driver 300 of the touch module may provide the touch driving signal TDS having the different frequency to the touch panel 400. In addition, the touch panel 400 may be the touch panel of the self-dot type. Therefore, the number of different frequencies may increase. Accordingly, EMI may be reduced even when the size of the touch panel 400 is large, while maintaining high touch performance.

Each of the touch lines TL may transmit the touch sensing signal TSS to the touch drivers TIC through the multiplexers MUX.

For example, the first touch line TL1 may transmit the first touch sensing signal TSS1 to the first touch driver TIC1 through the first multiplexer MUX1, the second touch line TL2 may transmit the first touch sensing signal TSS1 to the first touch driver TIC1 through the first multiplexer MUX1, the third touch line TL3 may transmit the first touch sensing signal TSS1 to the first touch driver TIC1 through the first multiplexer MUX1, and the fourth touch line TL4 may transmit the first touch sensing signal TSS1 to the first touch driver TIC1 through the first multiplexer MUX1.

For example, the fifth touch line TL5 may transmit the first touch sensing signal TSS1 to the first touch driver TIC1 through the second multiplexer MUX2, the sixth touch line TL6 may transmit the first touch sensing signal TSS1 to the first touch driver TIC1 through the second multiplexer MUX2, the seventh touch line TL7 may transmit the first touch sensing signal TSS1 to the first touch driver TIC1 through the second multiplexer MUX2, and the eighth touch line TL8 may transmit the first touch sensing signal TSS1 to the first touch driver TIC1 through the second multiplexer MUX2.

For example, the ninth touch line TL9 may transmit the second touch sensing signal TSS2 to the second touch driver TIC2 through the third multiplexer MUX3, the tenth touch line TL10 may transmit the second touch sensing signal TSS2 to the second touch driver TIC2 through the third multiplexer MUX3, the eleventh touch line TL11 may transmit the second touch sensing signal TSS2 to the second touch driver TIC2 through the third multiplexer MUX3, and the twelfth touch line TL12 may transmit the second touch sensing signal TSS2 to the second touch driver TIC2 through the third multiplexer MUX3.

For example, the thirteenth touch line TL13 may transmit the second touch sensing signal TSS2 to the second touch driver TIC2 through the fourth multiplexer MUX4, the fourteenth touch line TL14 may transmit the second touch sensing signal TSS2 to the second touch driver TIC2 through the fourth multiplexer MUX4, the fifteenth touch line TL15 may transmit the second touch sensing signal TSS2 to the second touch driver TIC2 through the fourth multiplexer MUX4, and the sixteenth touch line TL16 may transmit the second touch sensing signal TSS2 to the second touch driver TIC2 through the fourth multiplexer MUX4.

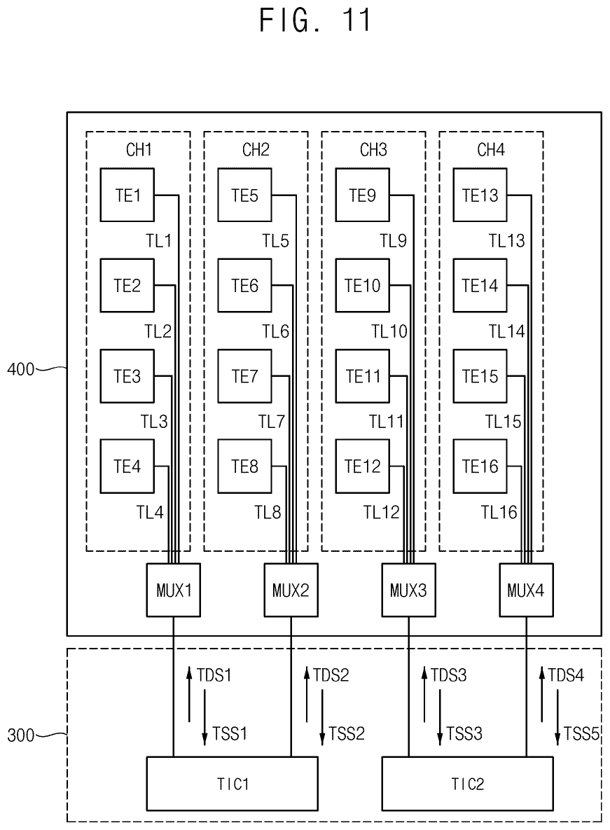

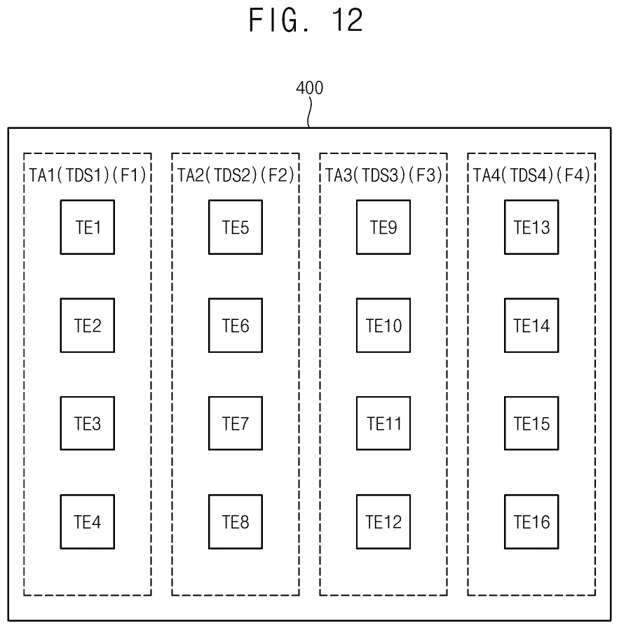

FIG. 11 is a diagram showing an example of an operation of a touch module of FIG. 3. FIG. 12 is a diagram showing a touch panel 400 of FIG. 11 divided into first to fourth touch areas TA1 to TA4.

Referring to FIG. 11 and FIG. 12, the touch module may include the touch panel driver 300 and the touch panel 400.

The touch panel driver 300 may include the touch drivers TIC. For example, the touch drivers TIC may include a first touch driver TIC1 and a second touch driver TIC2. The first touch driver TIC1 may provide a first touch driving signal TDS1 having a first frequency F1 and a second touch driving signal TDS2 having a second frequency F2 to the touch panel 400. The second touch driver TIC2 may provide a third touch driving signal TDS3 having a third frequency F3 and a fourth touch driving signal TDS4 having a fourth frequency F4 to the touch panel 400. In an embodiment, the frequences F1, F2, F3, and F4 are all different from one another. In another embodiment, the second frequency F2 is different from the first and third frequencies F1 and F3, and the fourth frequency F4 is the same as the first frequency F1.

The touch panel 400 may be the touch panel of the self-dot type. The touch panel 400 of the self-dot type may include the touch electrodes TE, the touch lines TL connected to the touch electrodes TE, and the multiplexers MUX connected to the touch lines TL. For example, the touch electrodes TE may include first to sixteenth touch electrodes TE1 to TE16. For example, the touch lines TL may include first to sixteenth touch lines TL1 to TL16. For example, the multiplexers MUX may include first to fourth multiplexers MUX1 to MUX4.

The first to fourth touch electrodes TE1 to TE4 may form a first channel CH1 and may be connected to the first to fourth touch lines TL1 to TL4, and the first to fourth touch lines TL1 to TL4 may be connected to the first multiplexer MUX1. The first touch driving signal TDS1 having the first frequency F1 may be provided from the first multiplexer MUX1.

The fifth to eighth touch electrodes TE5 to TE8 may form a second channel CH2 and may be connected to the fifth to eighth touch lines TL5 to TL8, and the fifth to eighth touch lines TL5 to TL8 may be connected to the second multiplexer MUX2. The second touch driving signal TDS2 having the second frequency F2 may be provided to the second multiplexer MUX2.

The ninth to twelfth touch electrodes TE9 to TE12 may form a third channel CH3 and may be connected to the ninth to twelfth touch lines TL9 to TL12, and the ninth to twelfth touch lines TL9 to TL12 may be connected to the third multiplexer MUX3. The third touch driving signal TDS3 having the third frequency F3 may be provided to the third multiplexer MUX3.

The thirteenth to sixteenth touch electrodes TE13 to TE16 may form a fourth channel CH4 and may be connected to the thirteenth to sixteenth touch lines TL13 to TL16, and the thirteenth to sixteenth touch lines TL13 to TL6 may be connected to the fourth multiplexer MUX4. The fourth touch driving signal TDS4 having the fourth frequency F4 may be provided to the fourth multiplexer MUX4.

Each of the multiplexers MUX may selectively provide the touch driving signal TDS provided from each of the touch drivers TIC to each of the touch lines TL, and each of the touch lines TL may transmit the touch driving signal TDS to each of the touch electrodes TE.

For example, the first multiplexer MUX1 may provide the first touch driving signal TDS1 to the first touch electrode TE1 through the first touch line TL1, or provide the first touch driving signal TDS1 to the second touch electrode TE2 through the second touch line TL2, or provide the first touch driving signal TDS1 to the third touch electrode TE3 through the third touch line TL3, or provide the first touch driving signal TDS1 to the fourth touch electrode TE4 through the fourth touch line TL4.

For example, the second multiplexer MUX2 may provide the second touch driving signal TDS2 to the fifth touch electrode TE5 through the fifth touch line TL5, or provide the second touch driving signal TDS2 to the sixth touch electrode TE6 through the sixth touch line TL6, or provide the second touch driving signal TDS2 to the seventh touch electrode TE7 through the seventh touch line TL7, or provide the second touch driving signal TDS2 to the eighth touch electrode TE8 through the eighth touch line TL8.

For example, the third multiplexer MUX3 may provide the third touch driving signal TDS3 to the ninth touch electrode TE9 through the ninth touch line TL9, or provide the third touch driving signal TDS3 to the tenth touch electrode TE10 through the tenth touch line TL10, or provide the third touch driving signal TDS3 to the eleventh touch electrode TE11 through the eleventh touch line TL11, or provide the third touch driving signal TDS3 to the twelfth touch electrode TE12 through the twelfth touch line TL12.

For example, the fourth multiplexer MUX4 may provide the fourth touch driving signal TDS4 to the thirteenth touch electrode TE13 through the thirteenth touch line TL13, or provide the fourth touch driving signal TDS4 to the fourteenth touch electrode TE14 through the fourteenth touch line TL14, or provide the fourth touch driving signal TDS4 to the fifteenth touch electrode TE15 through the fifteenth touch line TL15, or provide the fourth touch driving signal TDS4 to the sixteenth touch electrode TE16 through the sixteenth touch line TL16.

The touch panel 400 may be divided into a first touch area TA1 to which the first touch driving signal TDS1 is provided, a second touch area TA2 to which the second touch driving signal TDS2 is provided, a third touch area TA3 to which the third touch driving signal TDS3 is provided, and a fourth touch area TA4 to which the fourth touch driving signal TDS4 is provided. The first to fourth touch areas TA1 to TA4 may be arranged adjacent to along the row or along a row direction. For example, the first touch area TA1 may include the first to fourth touch electrodes TE1 to TE4, the second touch area TA2 may include the fifth to eighth touch electrodes TE5 to TE8, the third touch area TA3 may include the ninth to twelfth touch electrodes TE9 to TE12, and the fourth touch area TA4 may include the thirteenth to sixteenth touch electrodes TE13 to TE16.

The first touch driver DIC1 may generate the first touch driving signal TDS1 to provide the first touch driving signal TDS1 to the first touch area TA1, and then generate the second touch driving signal TDS2 to provide the second touch driving signal TDS2 to the second touch area TA2. The second touch driver DIC2 may generate the third touch driver signal TDS3 to provide third touch driver signal TDS3 to the third touch area TA3, and then generate the fourth touch driver signal TDS4 to provide the fourth touch driver signal TDS4 to the fourth touch area TA4. In this manner, a single touch driver may sequentially generate touch driver signals of different frequencies at different timings for respective touch areas.

Each of the touch lines TL may transmit the touch sensing signal TSS to the touch drivers TIC through the multiplexers MUX.

For example, the first touch line TL1 may transmit the first touch sensing signal TSS1 to the first touch driver TIC1 through the first multiplexer MUX1, the second touch line TL2 may transmit the first touch sensing signal TSS1 to the first touch driver TIC1 through the first multiplexer MUX1, the third touch line TL3 may transmit the first touch sensing signal TSS1 to the first touch driver TIC1 through the first multiplexer MUX1, and the fourth touch line TL4 may transmit the first touch sensing signal TSS1 to the first touch driver TIC1 through the first multiplexer MUX1.

For example, the fifth touch line TL5 may transmit the second touch sensing signal TSS2 to the first touch driver TIC1 through the second multiplexer MUX2, the sixth touch line TL6 may transmit the second touch sensing signal TSS2 to the first touch driver TIC1 through the second multiplexer MUX2, the seventh touch line TL7 may transmit the second touch sensing signal TSS2 to the first touch driver TIC1 through the second multiplexer MUX2, and the eighth touch line TL8 may transmit the second touch sensing signal TSS2 to the first touch driver TIC1 through the second multiplexer MUX2.

For example, the ninth touch line TL9 may transmit the third touch sensing signal TSS3 to the second touch driver TIC2 through the third multiplexer MUX3, the tenth touch line TL10 may transmit the third touch sensing signal TSS3 to the second touch driver TIC2 through the third multiplexer MUX3, the eleventh touch line TL11 may transmit the third touch sensing signal TSS3 to the second touch driver TIC2 through the third multiplexer MUX3, and the twelfth touch line TL12 may transmit the third touch sensing signal TSS3 to the second touch driver TIC2 through the third multiplexer MUX3.

For example, the thirteenth touch line TL13 may transmit the fourth touch sensing signal TSS4 to the second touch driver TIC2 through the fourth multiplexer MUX4, the fourteenth touch line TL14 may transmit the fourth touch sensing signal TSS4 to the second touch driver TIC2 through the fourth multiplexer MUX4, the fifteenth touch line TL15 may transmit the fourth touch sensing signal TSS4 to the second touch driver TIC2 through the fourth multiplexer MUX4, and the sixteenth touch line TL16 may transmit the fourth touch sensing signal TSS4 to the second touch driver TIC2 through the fourth multiplexer MUX4.

As such, each of the touch drivers TIC of the touch panel driver 300 of the touch module may provide a touch driving signal TDS having a different frequency to the touch panel 400. In addition, the touch panel 400 may be the touch panel of the self-dot type. Therefore, the number of different frequencies may increase. Accordingly, EMI may be reduced even with a large touch panel 400, while maintaining high touch performance.

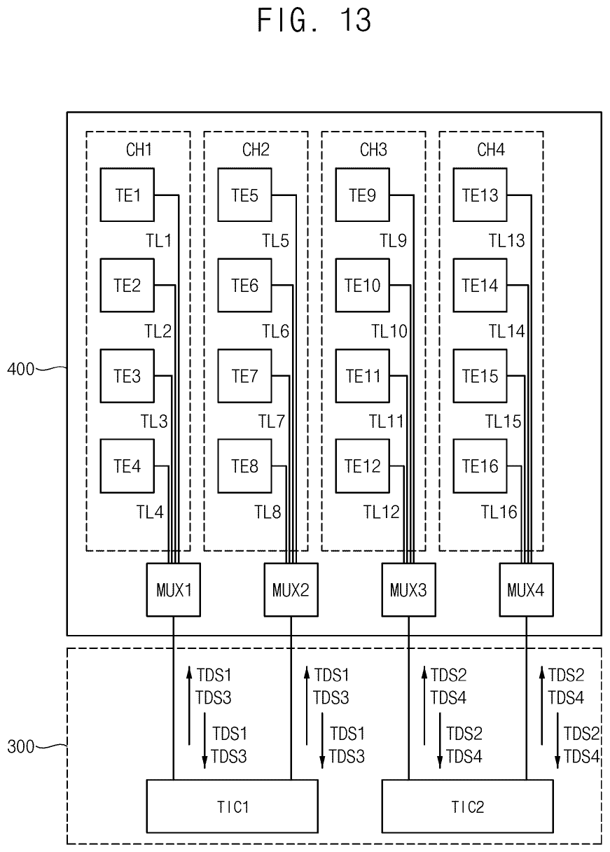

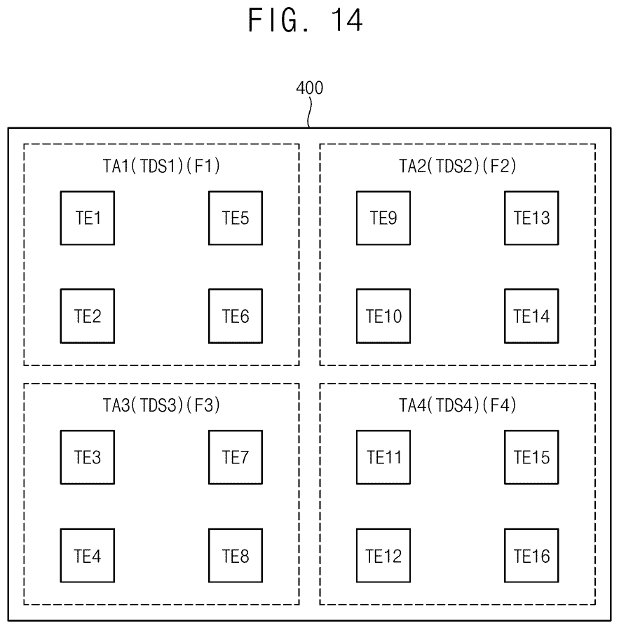

FIG. 13 is a diagram showing an example of an operation of a touch module of FIG. 3. FIG. 14 is a diagram showing a touch panel 400 of FIG. 11 divided into first to fourth touch areas TA1 to TA4.

Referring to FIG. 13 and FIG. 14, the touch module may include the touch panel driver 300 and the touch panel 400.

The touch panel driver 300 may include the touch drivers TIC. For example, the touch drivers TIC may include a first touch driver TIC1 and a second touch driver TIC2. The first touch driver TIC1 may provide a first touch driving signal TDS1 having a first frequency F1 and a third touch driving signal TDS3 having a third frequency F3 to the touch panel 400. The second touch driver TIC2 may provide a second touch driving signal TDS2 having a second frequency F2 and a fourth touch driving signal TDS4 having a fourth frequency F4 to the touch panel 400.

The touch panel 400 may be the touch panel of the self-dot type. The touch panel 400 of the self-dot type may include the touch electrodes TE, the touch lines TL connected to the touch electrodes TE, and the multiplexers MUX connected to the touch lines TL. For example, the touch electrodes TE may include first to sixteenth touch electrodes TE1 to TE16. For example, the touch lines TL may include first to sixteenth touch lines TL1 to TL16. For example, the multiplexers MUX may include first to fourth multiplexers MUX1 to MUX4.

The first to fourth touch electrodes TE1 to TE4 may form a first channel CH1 and may be connected to the first to fourth touch lines TL1 to TL4, and the first to fourth touch lines TL1 to TL4 may be connected to the first multiplexer MUX1. The first touch driving signal TDS1 having the first frequency F1 and the third touch driving signal TDS3 having the third frequency F3 may be provided from the first multiplexer MUX1.

The fifth to eighth touch electrodes TE5 to TE8 may form a second channel CH2 and may be connected to the fifth to eighth touch lines TL5 to TL8, and the fifth to eighth touch lines TL5 to TL8 may be connected to the second multiplexer MUX2. The first touch driving signal TDS1 having the first frequency F1 and the third touch driving signal TDS3 having the third frequency F3 may be provided to the second multiplexer MUX2.

The ninth to twelfth touch electrodes TE9 to TE12 may form a third channel CH3 and may be connected to the ninth to twelfth touch lines TL9 to TL12, and the ninth to twelfth touch lines TL9 to TL12 may be connected to the third multiplexer MUX3. The second touch driving signal TDS2 having the second frequency F2 and the fourth touch driving signal TDS4 having the fourth frequency F4 may be provided to the third multiplexer MUX3.

The thirteenth to sixteenth touch electrodes TE13 to TE16 may form a fourth channel CH4 and may be connected to the thirteenth to sixteenth touch lines TL13 to TL16, and the thirteenth to sixteenth touch lines TL13 to TL6 may be connected to the fourth multiplexer MUX4. The second touch driving signal TDS2 having the second frequency F2 and the fourth touch driving signal TDS4 having the fourth frequency F4 may be provided to the fourth multiplexer MUX4.

Each of the multiplexers MUX may selectively provide the touch driving signal TDS provided from each of the touch drivers TIC to each of the touch lines TL, and each of the touch lines TL may transmit the touch driving signal TDS to each of the touch electrodes TE.

For example, the first multiplexer MUX1 may provide the first touch driving signal TDS1 to the first touch electrode TE1 through the first touch line TL1, or provide the first touch driving signal TDS1 to the second touch electrode TE2 through the second touch line TL2, or provide the third touch driving signal TDS3 to the third touch electrode TE3 through the third touch line TL3, or provide the third touch driving signal TDS3 to the fourth touch electrode TE4 through the fourth touch line TL4.

For example, the second multiplexer MUX2 may provide the first touch driving signal TDS1 to the fifth touch electrode TE5 through the fifth touch line TL5, or provide the first touch driving signal TDS1 to the sixth touch electrode TE6 through the sixth touch line TL6, or provide the third touch driving signal TDS3 to the seventh touch electrode TE7 through the seventh touch line TL7, or provide the third touch driving signal TDS3 to the eighth touch electrode TE8 through the eighth touch line TL8.

For example, the third multiplexer MUX3 may provide the second touch driving signal TDS2 to the ninth touch electrode TE9 through the ninth touch line TL9, or provide the second touch driving signal TDS2 to the tenth touch electrode TE10 through the tenth touch line TL10, or provide the fourth touch driving signal TDS4 to the eleventh touch electrode TE11 through the eleventh touch line TL11, or provide the fourth touch driving signal TDS4 to the twelfth touch electrode TE12 through the twelfth touch line TL12.

For example, the fourth multiplexer MUX4 may provide the second touch driving signal TDS2 to the thirteenth touch electrode TE13 through the thirteenth touch line TL13, or provide the second touch driving signal TDS2 to the fourteenth touch electrode TE14 through the fourteenth touch line TL14, or provide the fourth touch driving signal TDS4 to the fifteenth touch electrode TE15 through the fifteenth touch line TL15, or provide the fourth touch driving signal TDS4 to the sixteenth touch electrode TE16 through the sixteenth touch line TL16.

The touch panel 400 may be divided into a first touch area TA1 to which the first touch driving signal TDS1 is provided, a second touch area TA2 to which the second touch driving signal TDS2 is provided, a third touch area TA3 to which the third touch driving signal TDS3 is provided, and a fourth touch area TA4 to which the fourth touch driving signal TDS4 is provided. The first touch area TA1 and the second touch area TA2 may be arranged adjacent along the row or row direction. The third touch area TA3 and the fourth touch area TA4 may be arranged adjacent along the row or row direction. The first touch area TA1 and the third touch area TA3 may be arranged adjacent along the column or column direction. The second touch area TA2 and the fourth touch area TA4 may be arranged adjacent along the column or column direction. The first to fourth touch areas TA1, TA2, TA3, and TA4 may be arranged in a 2×2 configuration, with TA1 and TA2 positioned side by side in a first row, and TA3 and TA4 positioned side by side in a second row beneath them.

For example, the first touch area TA1 may include the first, second, fifth, and sixth touch electrodes TE1, TE2, TE5, TE6, the second touch area TA2 may include the ninth, tenth, thirteenth, and fourteenth touch electrodes TE9, TE10, TE13, TE14, the third touch area TA3 may include the third, fourth, seventh, and eighth touch electrodes TE3, TE4, TE7, TE8, and the fourth touch area TA4 may include the eleventh, twelfth, fifteenth, and sixteenth touch electrodes TE11, TE12, TE15, TE16.

The first touch driver DIC1 may generate the first touch driving signal TDS1 to provide the first touch driving signal TDS1 to the first touch electrode TE1 and the second touch electrode TE2 of the first touch area TA1, and then generate the third touch driving signal TDS3 to provide the third touch driving signal TDS3 to the third touch electrode TE3 and the fourth touch electrode TE4 of the third touch area TA3. The first touch driver DIC1 may generate the first touch driving signal TDS1 to provide the first touch driving signal TDS1 to the fifth touch electrode TE5 and the sixth touch electrode TE6 of the first touch area TA1, and then generate the third touch driving signal TDS3 to provide the third touch driving signal TDS3 to the seventh touch electrode TE7 and the eighth touch electrode TE8 of the third touch area TA3. The second touch driver DIC2 may generate the second touch driving signal TDS2 to provide the second touch driving signal TDS2 to the ninth touch electrode TE9 and the tenth touch electrode TE10 of the second touch area TA2, and then generate the fourth touch driving signal TDS4 to provide the fourth touch driving signal TDS4 to the eleventh touch electrode TE11 and the twelfth touch electrode TE12 of the fourth touch area TA4. The second touch driver DIC2 may generate the second touch driving signal TDS2 to provide the second touch driving signal TDS2 to the thirteenth touch electrode TE13 and the fourteenth touch electrode TE14 of the second touch area TA2, and then generate the fourth touch driving signal TDS4 to provide the fourth touch driving signal TDS4 to the fifteenth touch electrode TE15 and the sixteenth touch electrode TE16 of the fourth touch area TA4. In this manner, a single touch driver may generate touch driver signals with different frequencies at a different timings, and provide each touch driver signal to a different touch area.

Each of the touch lines TL may transmit the touch sensing signal TSS to the touch drivers TIC through the multiplexers MUX.

For example, the first touch line TL1 may transmit the first touch sensing signal TSS1 to the first touch driver TIC1 through the first multiplexer MUX1, the second touch line TL2 may transmit the first touch sensing signal TSS1 to the first touch driver TIC1 through the first multiplexer MUX1, the third touch line TL3 may transmit the third touch sensing signal TSS3 to the first touch driver TIC1 through the first multiplexer MUX1, and the fourth touch line TL4 may transmit the third touch sensing signal TSS3 to the first touch driver TIC1 through the first multiplexer MUX1.

For example, the fifth touch line TL5 may transmit the first touch sensing signal TSS1 to the first touch driver TIC1 through the second multiplexer MUX2, the sixth touch line TL6 may transmit the first touch sensing signal TSS1 to the first touch driver TIC1 through the second multiplexer MUX2, the seventh touch line TL7 may transmit the third touch sensing signal TSS3 to the first touch driver TIC1 through the second multiplexer MUX2, and the eighth touch line TL8 may transmit the third touch sensing signal TSS3 to the first touch driver TIC1 through the second multiplexer MUX2.

For example, the ninth touch line TL9 may transmit the second touch sensing signal TSS2 to the second touch driver TIC2 through the third multiplexer MUX3, the tenth touch line TL10 may transmit the second touch sensing signal TSS2 to the second touch driver TIC2 through the third multiplexer MUX3, the eleventh touch line TL11 may transmit the fourth touch sensing signal TSS4 to the second touch driver TIC2 through the third multiplexer MUX3, and the twelfth touch line TL12 may transmit the fourth touch sensing signal TSS4 to the second touch driver TIC2 through the third multiplexer MUX3.

For example, the thirteenth touch line TL13 may transmit the second touch sensing signal TSS2 to the second touch driver TIC2 through the fourth multiplexer MUX4, the fourteenth touch line TL14 may transmit the second touch sensing signal TSS2 to the second touch driver TIC2 through the fourth multiplexer MUX4, the fifteenth touch line TL15 may transmit the fourth touch sensing signal TSS4 to the second touch driver TIC2 through the fourth multiplexer MUX4, and the sixteenth touch line TL16 may transmit the fourth touch sensing signal TSS4 to the second touch driver TIC2 through the fourth multiplexer MUX4.

Accordingly, each touch driver TIC of the touch panel driver 300 of the touch module may provide a touch driving signal TDS having a different frequency to the touch panel 400. In addition, the touch panel 400 may be the touch panel of the self-dot type. Therefore, the number of different frequencies may increase. Accordingly, EMI may be reduced while the size of the touch panel 400 is large and the touch function maintains high.

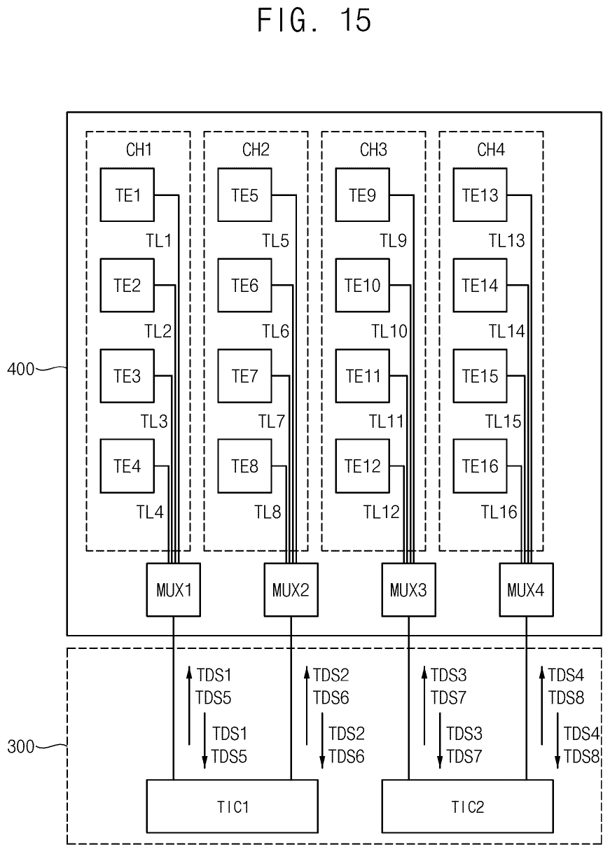

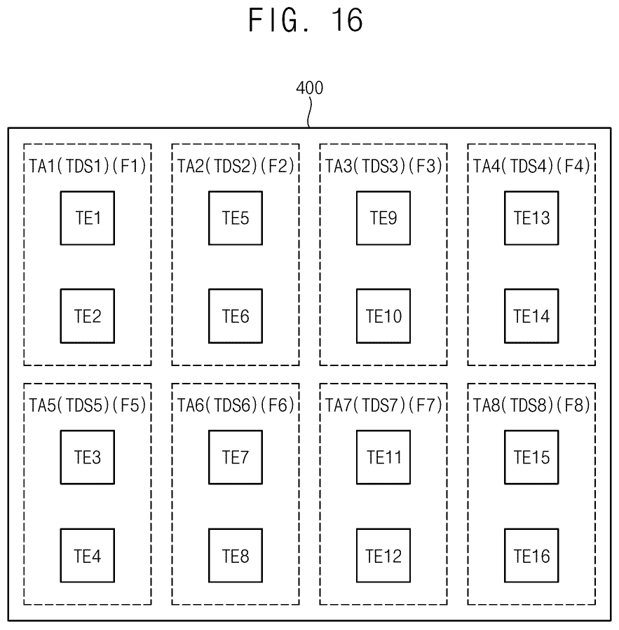

FIG. 15 is a diagram showing an example of an operation of a touch module of FIG. 3. FIG. 16 is a diagram showing a touch panel 400 of FIG. 15 divided into first to eighth touch areas TA1 to TA8.

Referring to FIGS. 15 and 16, the touch module may include the touch panel driver 300 and the touch panel 400.

The touch panel driver 300 may include the touch drivers TIC. For example, the touch drivers TIC may include a first touch driver TIC1 and a second touch driver TIC2. The first touch driver TIC1 may provide a first touch driving signal TDS1 having a first frequency F1, a second touch driving signal TDS2 having a second frequency F2, a fifth touch driving signal TDS5 having a fifth frequency F5, and a sixth touch driving signal TDS6 having a sixth frequency F6 to the touch panel 400. The second touch driver TIC2 may provide a third touch driving signal TDS3 having a third frequency F3, a fourth touch driving signal TDS4 having a fourth frequency F4, a seventh touch driving signal TDS7 having a seventh frequency F7, and an eighth touch driving signal TDS8 having an eighth frequency F8 to the touch panel 400.

The touch panel 400 may be the touch panel of the self-dot type. The touch panel 400 of the self-dot type may include the touch electrodes TE, the touch lines TL connected to the touch electrodes TE, and the multiplexers MUX connected to the touch lines TL. For example, the touch electrodes TE may include first to sixteenth touch electrodes TE1 to TE16. For example, the touch lines TL may include first to sixteenth touch lines TL1 to TL16. For example, the multiplexers MUX may include first to fourth multiplexers MUX1 to MUX4.

The first to fourth touch electrodes TE1 to TE4 may form a first channel CH1 and may be connected to the first to fourth touch lines TL1 to TL4, and the first to fourth touch lines TL1 to TL4 may be connected to the first multiplexer MUX1. The first touch driving signal TDS1 having the first frequency F1 and the fifth touch driving signal TDS5 having the fifth frequency F5 may be provided from the first multiplexer MUX1.

The fifth to eighth touch electrodes TE5 to TE8 may form a second channel CH2 and may be connected to the fifth to eighth touch lines TL5 to TL8, and the fifth to eighth touch lines TL5 to TL8 may be connected to the second multiplexer MUX2. The second touch driving signal TDS2 having the second frequency F2 and the sixth touch driving signal TDS6 having the sixth frequency F6 may be provided to the second multiplexer MUX2.

The ninth to twelfth touch electrodes TE9 to TE12 may form a third channel CH3 and may be connected to the ninth to twelfth touch lines TL9 to TL12, and the ninth to twelfth touch lines TL9 to TL12 may be connected to the third multiplexer MUX3. The third touch driving signal TDS3 having the third frequency F3 and the seventh touch driving signal TDS7 having the seventh frequency F7 may be provided to the third multiplexer MUX3.

The thirteenth to sixteenth touch electrodes TE13 to TE16 may form a fourth channel CH4 and may be connected to the thirteenth to sixteenth touch lines TL13 to TL16, and the thirteenth to sixteenth touch lines TL13 to TL6 may be connected to the fourth multiplexer MUX4. The fourth touch driving signal TDS4 having the fourth frequency F4 and the eighth touch driving signal TDS8 having the eighth frequency F8 may be provided to the fourth multiplexer MUX4.

Each of the multiplexers MUX may selectively provide the touch driving signal TDS provided from each of the touch drivers TIC to each of the touch lines TL, and each of the touch lines TL may transmit the touch driving signal TDS to each of the touch electrodes TE.

For example, the first multiplexer MUX1 may provide the first touch driving signal TDS1 to the first touch electrode TE1 through the first touch line TL1, or provide the first touch driving signal TDS1 to the second touch electrode TE2 through the second touch line TL2, or provide the fifth touch driving signal TDS5 to the third touch electrode TE3 through the third touch line TL3, or provide the fifth touch driving signal TDS5 to the fourth touch electrode TE4 through the fourth touch line TL4.

For example, the second multiplexer MUX2 may provide the second touch driving signal TDS2 to the fifth touch electrode TE5 through the fifth touch line TL5, or provide the second touch driving signal TDS2 to the sixth touch electrode TE6 through the sixth touch line TL6, or provide the sixth touch driving signal TDS6 to the seventh touch electrode TE7 through the seventh touch line TL7, or provide the sixth touch driving signal TDS6 to the eighth touch electrode TE8 through the eighth touch line TL8.

For example, the third multiplexer MUX3 may provide the third touch driving signal TDS3 to the ninth touch electrode TE9 through the ninth touch line TL9, or provide the third touch driving signal TDS3 to the tenth touch electrode TE10 through the tenth touch line TL10, or provide the seventh touch driving signal TDS7 to the eleventh touch electrode TE11 through the eleventh touch line TL11, or provide the seventh touch driving signal TDS7 to the twelfth touch electrode TE12 through the twelfth touch line TL12.

For example, the fourth multiplexer MUX4 may provide the fourth touch driving signal TDS4 to the thirteenth touch electrode TE13 through the thirteenth touch line TL13, the fourth touch driving signal TDS4 to the fourteenth touch electrode TE14 through the fourteenth touch line TL14, the eighth touch driving signal TDS8 to the fifteenth touch electrode TE15 through the fifteenth touch line TL15, or the eighth touch driving signal TDS8 to the sixteenth touch electrode TE16 through the sixteenth touch line TL16.

The touch panel 400 may be divided into a first touch area TA1 to which the first touch driving signal TDS1 is provided, a second touch area TA2 to which the second touch driving signal TDS2 is provided, a third touch area TA3 to which the third touch driving signal TDS3 is provided, a fourth touch area TA4 to which the fourth touch driving signal TDS4 is provided, a fifth touch area TA5 to which the fifth touch driving signal TDS5 is provided, a sixth touch area TA6 to which the sixth touch driving signal TDS6 is provided, a seventh touch area TA7 to which the seventh touch driving signal TDS7 is provided, and an eighth touch area TA8 to which the eighth touch driving signal TDS8 is provided. The first to fourth touch areas TA1 to TA4 may be arranged adjacently along the row or row direction. The fifth to eighth touch areas TA5 to TA8 may be arranged adjacently along the row or row direction. The first touch area TA1 and the fifth touch area TA5 may be arranged adjacently along the column or column direction. The second touch area TA2 and the sixth touch area TA6 may be arranged adjacently along the column or column direction. The third touch area TA3 and the seventh touch area TA7 may be arranged adjacently along the column or column direction. The fourth touch area TA4 and the eighth touch area TA8 may be arranged adjacently along the column or column direction. For example, the touch areas TA1 through TA8 may be arranged in a 2×4 grid configuration, with TA1 to TA4 forming a first row and TA5 to TA8 forming a second row positioned below the first row.

For example, the first touch area TA1 may include the first touch electrode TE1 and the second touch electrode TE2, the second touch area TA2 may include the fifth touch electrode TE5 and the sixth touch electrode TE6, the third touch area TA3 may include the ninth touch electrode TE9 and the tenth touch electrode TE10, the fourth touch area TA4 may include the thirteenth touch electrode TE13 and the fourteenth touch electrode TE14, the fifth touch area TA5 may include the third touch electrode TE3 and the fourth touch electrode TE4, the sixth touch area TA6 may include the seventh touch electrode TE7 and the eighth touch electrode TE8, the seventh touch area TA7 may include the eleventh touch electrode TE11 and the twelfth touch electrode TE12, and the eighth touch area TA8 may include the fifteenth touch electrode TE15 and the sixteenth touch electrode TE16.

The first touch driver DIC1 may generate the first touch driving signal TDS1 to provide the first touch driving signal TDS1 to the first touch electrode TE1 and the second touch electrode TE2 of the first touch area TA1, and then generate the fifth touch driving signal TDS5 to provide the fifth touch driving signal TDS5 to the third touch electrode TE3 and the fourth touch electrode TE4 of the fifth touch area TA5. The first touch driver DIC1 may generate the second touch driving signal TDS2 to provide the second touch driving signal TDS2 to the fifth touch electrode TE5 and the sixth touch electrode TE6 of the first touch area TA1, and then generate the sixth touch driving signal TDS6 to provide the sixth touch driving signal TDS6 to the seventh touch electrode TE7 and the eighth touch electrode TE8 of the third touch area TA3. The second touch driver DIC2 may generate the third touch driving signal TDS3 to provide the third touch driving signal TDS3 to the ninth touch electrode TE9 and the tenth touch electrode TE10 of the third touch area TA3, and then generate the seventh touch driving signal TDS7 to provide the seventh touch driving signal TDS7 to the eleventh touch electrode TE11 and the twelfth touch electrode TE12 of the seventh touch area TA7. The second touch driver DIC2 may generate the fourth touch driving signal TDS4 to provide the fourth touch driving signal TDS4 to the thirteenth touch electrode TE13 and the fourteenth touch electrode TE14 of the fourth touch area TA4, and then generate the eighth touch driving signal TDS8 to provide the eighth touch driving signal TDS8 to the fifteenth touch electrode TE15 and the sixteenth touch electrode TE16 of the eighth touch area TA8. In this way, a single touch driver may sequentially generate touch driver signals with different frequencies at different timings, and apply each signal to a different touch area.

Each of the touch lines TL may transmit the touch sensing signal TSS to the touch drivers TIC through the multiplexers MUX.

For example, the first touch line TL1 may transmit the first touch sensing signal TSS1 to the first touch driver TIC1 through the first multiplexer MUX1, the second touch line TL2 may transmit the first touch sensing signal TSS1 to the first touch driver TIC1 through the first multiplexer MUX1, the third touch line TL3 may transmit the fifth touch sensing signal TSS5 to the first touch driver TIC1 through the first multiplexer MUX1, and the fourth touch line TL4 may transmit the fifth touch sensing signal TSS5 to the first touch driver TIC1 through the first multiplexer MUX1.

For example, the fifth touch line TL5 may transmit the second touch sensing signal TSS2 to the first touch driver TIC1 through the second multiplexer MUX2, the sixth touch line TL6 may transmit the second touch sensing signal TSS2 to the first touch driver TIC1 through the second multiplexer MUX2, the seventh touch line TL7 may transmit the sixth touch sensing signal TSS6 to the first touch driver TIC1 through the second multiplexer MUX2, and the eighth touch line TL8 may transmit the sixth touch sensing signal TSS6 to the first touch driver TIC1 through the second multiplexer MUX2.

For example, the ninth touch line TL9 may transmit the third touch sensing signal TSS3 to the second touch driver TIC2 through the third multiplexer MUX3, the tenth touch line TL10 may transmit the third touch sensing signal TSS3 to the second touch driver TIC2 through the third multiplexer MUX3, the eleventh touch line TL11 may transmit the seventh touch sensing signal TSS7 to the second touch driver TIC2 through the third multiplexer MUX3, and the twelfth touch line TL12 may transmit the seventh touch sensing signal TSS7 to the second touch driver TIC2 through the third multiplexer MUX3.

For example, the thirteenth touch line TL13 may transmit the fourth touch sensing signal TSS4 to the second touch driver TIC2 through the fourth multiplexer MUX4, the fourteenth touch line TL14 may transmit the fourth touch sensing signal TSS4 to the second touch driver TIC2 through the fourth multiplexer MUX4, the fifteenth touch line TL15 may transmit the eighth touch sensing signal TSS8 to the second touch driver TIC2 through the fourth multiplexer MUX4, and the sixteenth touch line TL16 may transmit the eighth touch sensing signal TSS8 to the second touch driver TIC2 through the fourth multiplexer MUX4.

Accordingly, each touch driver TIC of the touch panel driver 300 of the touch module may provide a touch driving signal TDS with a different frequency to the touch panel 400. In addition, the touch panel 400 may be the touch panel of the self-dot type. Therefore, the number of different frequencies may increase. Accordingly, EMI may be reduced even when the touch panel 400 is large, while maintaining high touch performance.

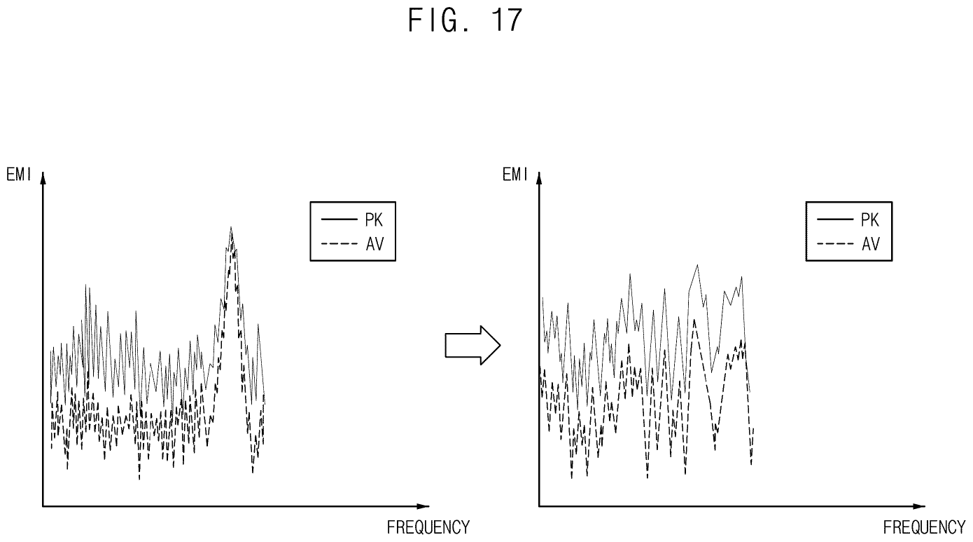

FIG. 17 is a graph showing a change in an EMI according to a frequency of a touch driving signal TDS.

Referring to FIG. 17, for example, the first touch driver DIC1 may generate a first touch driving signal TDS1 having a first frequency F1, and the second touch driver DIC2 may generate a first touch driving signal TDS1 having a second frequency F2.

The left graph of FIG. 17 exemplifies a case where the first frequency F1 is equal to the second frequency F2, and the right graph of FIG. 17 exemplifies a case where the first frequency F1 is different from the second frequency F2. The left graph and the right graph include a peak value PK and an average value AV.

When the left graph and the right graph are compared, an EMI peak value of the peak value PK and an EMI peak value of the average value AV in the left graph may be greater than an EMI peak value of the peak value PK and an EMI peak value of the average value AV in the right graph.

As such, when each touch driver TIC of the touch panel driver 300 of the touch module provides touch driving signals TDS having different frequencies to the touch panel 400, EMI may be reduced.

As described above, in the present embodiment, the touch panel 400 may be the touch panel of the self-dot type rather than the touch panel of the mutual type. This may be due to the limitations of the touch panel of the mutual type.

Referring back to FIG. 2, as described above, the touch panel of the mutual type may include the transmitting touch electrode lines TX and the receiving touch electrode lines RX. For example, the transmitting touch electrode lines TX may extend along the row, and the receiving touch electrode lines RX may extend along the column. Each of the transmitting touch electrode lines TX may form the touch capacitors with each of the receiving touch electrode lines RX. Therefore, due to the structure of each of the transmitting touch electrode lines TX, all of the touch capacitors formed along a given row share the same transmitting touch electrode line TX and inevitably receive the same touch driving signal. As a result, a mutual-type touch panel cannot provide different touch driving signals along the row, but may provide different touch driving signals along the column.

On the other hand, in the touch panel 400 of the self-dot type, each of the touch electrodes TE is connected to each of the different touch lines TL. Therefore, the touch panel 400 of the self-dot type may provide a different touch driving signal along the column, as well as a different touch driving signal along the row. That is, the touch panel 400 of the self-dot type may provide touch driving signals TDS having different frequencies to the touch panel 400 along the row and the column.

As such, in the present embodiment, when the touch panel 400 is of the self-dot type rather than the mutual type, the touch module may use touch driving signals TDS having more diverse frequencies. As the number of the different frequencies increases, EMI may be reduced. Accordingly, the EMI may be further reduced.

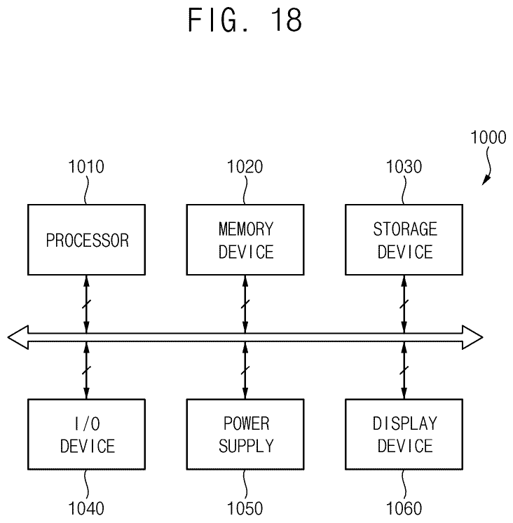

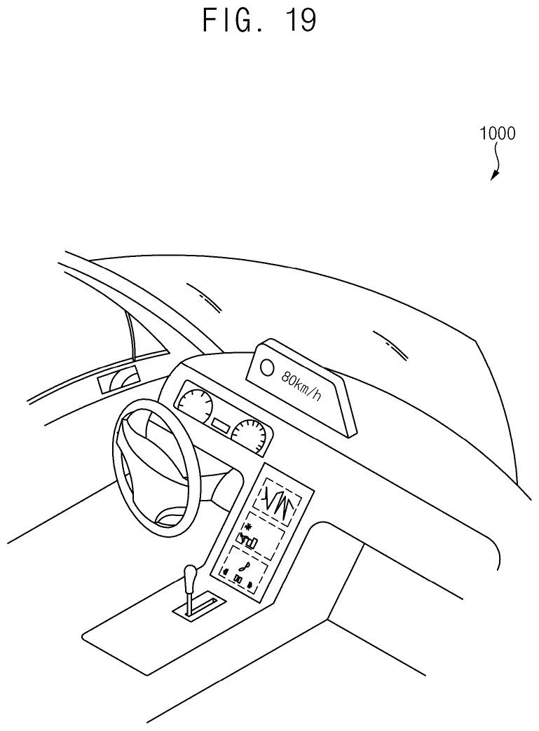

FIG. 18 is a block diagram showing an electronic device 1000. FIG. 19 is a diagram showing an embodiment in which an electronic device 1000 of FIG. 18 is implemented as a car window.

Referring to FIGS. 18 and 19, an electronic device 1000 may include a processor 1010, a memory device 1020, a storage device 1030, an input/output I/O device 1040, a power supply 1050, and a display device 10060. The display device 10060 may be the display device 100 of FIG. 1. In addition, the electronic device 1000 may further include a plurality of ports for communicating with a video card, a sound card, a memory card, a universal serial bus USB device, other electronic device, and the like.

In an embodiment, as shown in FIG. 19, the electronic device 1000 may be implemented as a car window. However, the electronic device 1000 is not limited thereto. For example, the electronic device 1000 may be implemented as a cellular phone, a video phone, a smart pad, a smart phone, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 10060.

The power supply 1050 may provide power for operations of the electronic device 1000.

The display device 10060 may be connected to other components through buses or other communication links.

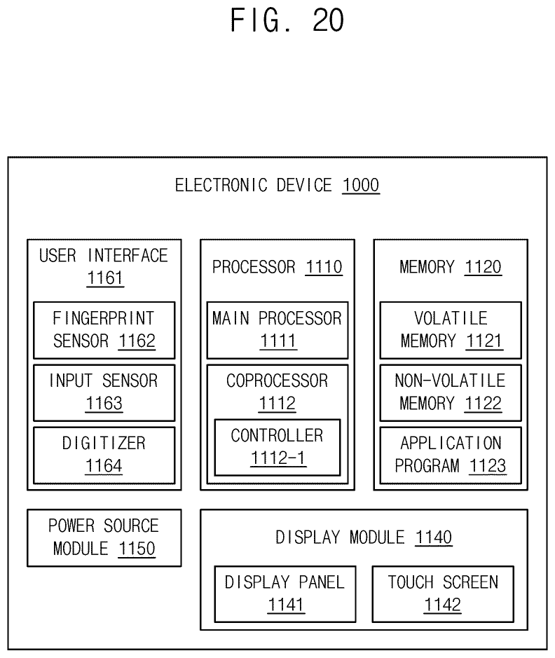

FIG. 20 is a diagram illustrating an electronic device according to an embodiment of the present invention. Referring to FIG. 20, the electronic device 1000 according to one embodiment of the present invention may output various information (e.g., images, text, music, etc.) through a display module 1140, which, for example, may correspond to the display device shown in FIG. 1. When a processor 1110 (e.g., 1010) executes an application stored in a memory 1120 (e.g., 1020), the display module 1140 (e.g., 1060) may provide application information to a user through a display panel 1141.

In some embodiments, the electronic device 1000 may be configured as a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 may be an AR/VR headset.

In some embodiments, memory 1120 may store information such as software codes for operating an application program 1123. The application program 1123 may include software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with the user interface 1161 or touch screen 1142, allowing a user to launch, navigate, and utilize the program through user inputs such as touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

As another example, when a user wishes to make a phone call, the user taps the telephone icon displayed on the display module 1140, the processor 1110 may execute a phone application program stored in the memory 1120. A telephone keypad may be presented on the display panel 1141 for the user to enter a phone number to call.

As another example, the display module 1140 may be integrated into an electronic device 1000, such as a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device shown in FIG. 1.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as blood pressure, moisture, or body mass.

The input sensor 1163 may sense user interactions including touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display module 1140 may be used to implement the display device 1060. The display panel 1141 may include the display unit shown in FIG. 1.

The power source module 1150 (e.g., 1050) may supply power to the components of the electronic device 1000. The power source module 1150 may be used to implement the power supply 1050. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140.

The inventive concepts may be applied to any display device and any electronic device including the touch panel. For example, the inventive concepts may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings of the inventive concept. Accordingly, all such modifications are intended to be included within the scope of the inventive concept as defined in the claims. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims.

What is claimed is:

1. A touch module comprising:
a touch panel including touch electrodes; and
a touch panel driver configured to provide a touch driving signal to the touch panel and detect a touch of an object based on a touch sensing signal received from the touch panel in response to the touch driving signal,
wherein the touch panel is a self-dot type, and
wherein the touch panel driver includes touch drivers, and each of the touch drivers is configured to provide a touch driving signal having a different frequency to the touch panel.

2. The touch module of claim 1, wherein, as a number of the different frequency increases, an Electromagnetic interference) (EMI) decreases.

3. The touch module of claim 1, wherein the touch electrodes included in the touch panel of the self-dot type form touch capacitors with the object, and the touch panel driver is configured to detect the touch of the object based on a capacitance change of each of the touch capacitors.

4. The touch module of claim 1, wherein the touch electrodes included in the touch panel of the self-dot type are arranged along a row and a column.

5. The touch module of claim 4, wherein the touch panel further includes touch lines connected to the touch electrodes and multiplexers connected to the touch lines, and each of the touch drivers are configured to provide the touch driving signal to each of the multiplexers.

6. The touch module of claim 5, wherein touch driving signals applied to the touch electrodes arranged adjacently along the row have a different timing.

7. The touch module of claim 1, wherein, when the touch drivers include a first touch driver configured to output a first touch driving signal having a first frequency and a second touch driver configured to output a second touch driving signal having a second frequency, the touch panel includes a first touch area and a second touch area arranged adjacently along a row, and the first touch driving signal is applied to the touch electrodes included in the first touch area, and the second touch driving signal is applied to the touch electrodes included in the second touch area.

8. The touch module of claim 7, wherein the first frequency and the second frequency are different from each other.

9. The touch module of claim 8, wherein the first frequency and the second frequency are selected such that a least common multiple of a reciprocal of the first frequency and a reciprocal of the second frequency is greater than a predetermined threshold.

10. The touch module of claim 9, wherein, as the least common multiple of the first frequency and the second frequency increases, an Electromagnetic interference (EMI) decreases.

11. The touch module of claim 7, wherein, when the first touch driver is configured to output the first touch driving signal having the first frequency and a third touch driving signal having a third frequency and the second touch driver is configured to output the second touch driving signal having the second frequency and a fourth touch driving signal having a fourth frequency, the touch panel further includes a third touch area and a fourth touch area arranged adjacently along the row, the third touch area is arranged adjacently to the first touch area along a column, the fourth touch area is arranged adjacently to the second touch area along the column, the third touch driving signal is applied to the touch electrodes included in the third touch area, and the fourth touch driving signal is applied to the touch electrodes included in the fourth touch area.

12. The touch module of claim 11, wherein the first frequency, the second frequency, the third frequency, and the fourth frequency are different from each other.

13. A display device comprising:
a display module including a display panel, and a display panel driver configured to drive the display panel; and
a touch module including a touch panel, and a touch panel driver configured to drive the touch panel,
wherein the touch panel includes touch electrodes,
wherein the touch panel driver is configured to provide a touch driving signal to the touch panel and detect a touch of an object based on a touch sensing signal received from the touch panel in response to the touch driving signal,
wherein the touch panel is a self-dot type, and
wherein the touch panel driver includes touch drivers, and each of the touch drivers is configured to provide a touch driving signal having a different frequency to the touch panel.

14. The display device of claim 13, wherein, as a number of the different frequency increases, an Electromagnetic interference (EMI) decreases.

15. The display device of claim 13, wherein the touch electrodes included in the touch panel of the self-dot type form touch capacitors with the object, and the touch panel driver is configured to detect the touch of the object based on a capacitance change of each of the touch capacitors.

16. The display device of claim 13, wherein the touch electrodes included in the touch panel of the self-dot type are arranged along a row and a column.

17. The display device of claim 16, wherein the touch panel further includes touch lines connected to the touch electrodes and multiplexers connected to the touch lines, and each of the touch drivers are configured to provide the touch driving signal to each of the multiplexers.

18. The display device of claim 17, wherein touch driving signals applied to the touch electrodes arranged adjacently along the row have a different timing.

19. The display device of claim 13, wherein, when the touch drivers include a first touch driver configured to output a first touch driving signal having a first frequency and a second touch driver configured to output a second touch driving signal having a second frequency, the touch panel includes a first touch area and a second touch area arranged adjacently along a row, and the first touch driving signal is applied to the touch electrodes included in the first touch area, and the second touch driving signal is applied to the touch electrodes included in the second touch area.

20. An electronic device comprising:
a processor configured to output input image data and an input control signal;
a display module including a display panel, and a display panel driver configured to drive the display panel based on the input image data and the input control signal; and
a touch module including a touch panel, and a touch panel driver configured to drive the touch panel,
wherein the touch panel includes touch electrodes,
wherein the touch panel driver is configured to provide a touch driving signal to the touch panel and to detect a touch of an object based on a touch sensing signal received from the touch panel in response to the touch driving signal,
wherein the touch panel is a self-dot type, and
wherein the touch panel driver includes touch drivers, and each of the touch drivers is configured to provide a touch driving signal having a different frequency to the touch panel.
